(19) United States
(12) Patent Application Publication
(10) Pub. No.: US 2024/0060199 A1
(43) Pub. Date: Feb. 22, 2024

(54) REDUCTION OF CHALCOPYRITE BY AN AQUEOUS PHASE REDUCANT TO ENABLE HYDROMETALLURGICAL EXTRACTION OF COPPER

(71) Applicant: THE TRUSTEES OF COLUMBIA UNIVERSITY IN THE CITY OF NEW YORK, New York, NY (US)

(72) Inventors: Jonathan VARDNER, New York, NY (US); Alan WEST, Tenafly, NJ (US); Scott BANTA, Fairfield, CT (US)

(73) Assignee: THE TRUSTEES OF COLUMBIA UNIVERSITY IN THE CITY OF NEW YORK, New York, NY (US)

(21) Appl. No.: 18/270,560

(22) PCT Filed: Dec. 29, 2021
(86) PCT No.: PCT/US21/65450

§ 371 Date: Jun. 30, 2023

Related U.S. Application Data
(60) Provisional application No. 63/294,098, filed on Dec. 28, 2021.
(60) Provisional application No. 63/131,838, filed on Dec. 30, 2020.

(51) Int. Cl. C25C 1/12

(52) U.S. Cl. CPC C25C 1/12

(57) ABSTRACT

A copper concentrate such as chalcopyrite is contacted with an aqueous solution includes acids and a reducing agent, such as vanadium (II) ions, chromium (II) ions, or tungstozincic acid (H₆ZnW₁₂O₄₀). The aqueous solution reduces the copper in the copper concentrate, which can then dissolve into the solution for recovery therefrom, or precipitate out of solution as copper compounds or elemental copper for recovery in as a solid phase product. The solid phase product can then be isolated, dissolved, and further electrowinned to recover a copper product from the copper concentrate. Oxidized reducing agent can be recovered in an electrochemical device with ferrous iron reactants. Hydrometallurgical routes to convert copper concentrates to copper are potentially less expensive and less polluting than current pyrometallurgical processing and an advantageous response to environmental and economic pressures for increased copper production.

### CROSS REFERENCE TO RELATED APPLICATION(S)

This application is a national stage filing of International Patent Application No. PCT/US2021/065450, filed Dec. 29, 2021, which claims the benefit of U.S. Provisional Application Nos. 63/131,838, filed Dec. 30, 2020, and 63/294,098, filed Dec. 28, 2021, which are incorporated by reference as if disclosed herein in their entireties.

### STATEMENT REGARDING FEDERALLY SPONSORED RESEARCH AND DEVELOPMENT

This invention was made with government support under awards 1644869 awarded by the National Science Foundation and DE-AR0001340 awarded by the Department of Energy. The government has certain rights in the invention.

### BACKGROUND

Renewable energy sources are becoming more desirable in the 21^{st} century due to the environmental impact and increasing costs of fossil fuels. Renewable energy sources, however, may require five times as much copper as traditional power sources. Copper is abundant in renewables because its high electrical conductivity translates to efficient transmission of power, and its relatively low cost makes it economically favorable to other metals. For wind and solar plants, vast quantities of copper are required to connect components separated by large distances, including energy storage systems and the grid. A photovoltaic solar power system contains approximately 5.5 tons of Cu per MW, and a single wind farm can contain 4-15 million pounds of copper. A hybrid vehicle contains approximately 45 kilograms of copper in its wiring, motors, radiators, and brakes.

The high demand for copper is coinciding with a sharp decline in the grade of copper reserves, and as a result, copper scarcities are expected to arise in the coming decades. It is essential to extend the availability of new copper for several decades to facilitate the transition to renewable energy technologies.

The cost of copper production is expected to escalate in the coming decades. Researchers project a global peak in the copper industry by the year 2050 due in part to the high costs of copper production. The development of new processing techniques of copper-containing ore is important to reduce the costs of copper production and extend the availability of new copper for several decades.

Chalcopyrite (CuFeS₂) is the most abundant copper-containing mineral found in nature, accounting for approximately 70% of global copper reserves. The high demand for copper, however, is coinciding with a global peak in global copper production, which stems from the depletion of copper reserves and high costs associated with current copper production technologies. There is interest in shifting from pyrometallurgical to hydrometallurgical processing of CuFeS₂ for environmentally and economically sustainable copper production.

The CuFeS₂ mineral is typically mined, concentrated, and then smelted to produce copper. The pyrometallurgical process is characterized by high investment costs, high operating costs, and the potential release of environmentally deleterious by-products such as sulfur dioxide and arsenic. Table 1 shows an outline for the key operating steps and associated costs of the pyrometallurgical process. The mining and crushing of ore is required to crush the ore to the millimeter scale. Ball milling is used to further reduce the particle size to the micron scale. Flotation is used to separate the sulfide mineral phases from the silicate phases. Transport for smelting is required to bring the concentrated ore to overseas smelters. Smelting is required to convert CuFeS₂ to Cu, but may release sulfur dioxide (SO₂) and arsenic (As) as by-products. Lastly, electrochemical refining is used to generate high quality Cu for sale.

TABLE 1
Investment and operating costs of the pyrometallurgical
processing route of CuFeS₂

| | Investment cost | Operating Cost |
|---|---|---|
| Component | ($/tonne of Cu per year) | ($/kg of Cu) |
| Open-Pit Mining | 10,000 | 0.5 |
| Ball Milling/Flotation | 10,000 | 1.3 |
| Smelting | 9,000 | 0.1 |
| Electrochemical Refining | 1,000 | 0.1 |

The investment costs shown in Table 1 may be converted to an indirect operating costs by assuming 12% capital investment recovery per year, which includes the cost of interest. The working capital is assumed to be 10% per annual tonne of Cu, and therefore, the total investment cost is estimated to be $33,000/tonne of Cu per year. The direct ($2/kg of Cu) and indirect ($4/kg of Cu) costs of copper production sum to $6/kg of Cu, which is close to the selling price.

Thus, there is substantial interest in pursuing the hydrometallurgical processing of CuFeS₂ in order to lower the costs and environmental impact of future copper production. The hydrometallurgical leaching of CuFeS₂ is generally conducted with Fe³⁺ as the oxidant, although reagents such as O₂ and H₂O₂ have also been studied. The diffusion of the oxidant is generally inhibited by the formation of a passivation layer on the surface of the mineral. There persists a disagreement regarding the chemical makeup of the passivation layer and the mechanism of its formation. In various media, elemental sulfur, disulfide, and polysulfide have been identified on the chalcopyrite surface, all of which likely contribute to the passivation. The electro-dissolution of CuFeS₂ showed that the range of applied potential affects the chemical phase of the passivating layer. An XPS analysis of electro-dissolved CuFeS₂ revealed that a metal-deficient sulfide film including cuprous sulfide (Cu—S) and iron sulfide (Fe—S) bonds is the most probable phase that passivates the CuFeS₂ surface for potentials greater than 0.90 V_{SHE}. The indigenous bacteria that increase the kinetics for the oxidation of other copper-sulfides do not significantly improve the kinetics of CuFeS₂ oxidation. Silver ions may alter the reaction pathway of CuFeS₂, which mitigates the severity of the sulfur passivation. The electro-dissolution of CuFeS₂ with silver ions present revealed the formation of Ag₂S in the passivation layer. The formation of Ag₂S requires the formation of a sulfur vacancy and a pair of holes, which abates the passivative nature of the film and improves the rate of CuFeS₂ dissolution. Although silver ions are effective catalysts, they are not used in practice due to their high cost.

It may be possible to circumvent the challenges associated with CuFeS₂ passivation by converting CuFeS₂ to a mineral phase more suitable for chemical oxidation. Studies showed that CuFeS₂ can be converted to chalcocite (Cu₂S) using solid copper, sulfur dioxide gas, iron, and aluminum as reducing agents. The chemical reducing agents, however, typically yield relatively low conversions and require fine CuFeS₂ particle sizes or high temperatures.

An alternative approach has been developed to electrochemically reduce CuFeS₂ to Cu₂S in acidic solution. Studies have been conducted to analyze the effects of operating parameters such as acid concentration, CuFeS₂ pulp density, and temperature. An aluminum cathode is thought to convert CuFeS₂ to Cu₂S more efficiently than copper, carbon, or platinum cathode materials, and it has been shown that direct contact between the mineral phase and the cathode is required for the reaction to proceed. Reactions 1 and 2 show that CuFeS₂ can be electrochemically reduced to Cu₂S and subsequently Cu₂O. These reactions have undergone a number of optimizations by modifying the electrolyte, separator, electrode materials, and reactor design.

2CuFeS₂+6H⁺2e⁻→Cu₂S+2Fe²⁺+3H₂S [1]

2Cu₂S+4H⁺+O₂+4e⁻→2Cu₂O+2H₂S [2]

Reactions 1 and 2 are in direct competition with the hydrogen evolution reaction, and therefore typically operate at faradaic efficiencies below 40%. These slurry reactions also present potential engineering challenges such as reactor plugging and electrode fouling.

### SUMMARY

Some aspects of the present disclosure are directed to a method of producing a copper product from a copper concentrate. In some embodiments, the method includes providing a composition including a copper concentrate. In some embodiments, the method includes contacting the composition with an aqueous solution including one or more chemical reducing agents. In some embodiments, the method includes reacting at least a portion of the copper concentrate with the chemical reducing agent to reduce copper within the copper concentrate. In some embodiments, the method includes isolating a solid phase reaction product, the solid phase reaction product including a copper product. In some embodiments, the method includes contacting the solid phase reaction product with an acidic stream to produce a dissolved copper product, the acidic stream including one or more acids. In some embodiments, the method includes electrowinning the dissolved copper product to isolate the copper product and a recycled acid.

In some embodiments, the step of isolating a solid phase reaction product includes isolating a liquid phase reaction product, the liquid phase reaction product including an oxidized chemical reducing agent, and feeding the liquid phase reaction product to an electrochemical device. In some embodiments, the method includes reducing the oxidized chemical reducing agent at the electrochemical device to a recycled chemical reducing agent and contacting the recycled chemical reducing agent with the composition. In some embodiments, the method includes isolating a second copper product from the liquid phase reaction product. In some embodiments, the step of isolating a solid phase reaction product includes isolating a gaseous reaction product, the gaseous reaction product including hydrogen sulfide, contacting the gaseous reaction product with a stream of ferric iron to form a ferrous iron effluent stream and an elemental sulfur effluent stream, and recycling the ferrous iron effluent stream to the electrochemical device.

In some embodiments, the copper concentrate includes chalcopyrite. In some embodiments, the acidic stream includes a concentration of iron (III) sulfate, sulfuric acid, or combinations thereof. In some embodiments, the chemical reducing agents include vanadium (II) ions, compounds including vanadium (II) ions, chromium (II) ions, compounds including chromium (II) ions, tungstozincic acid (H₆ZnW₁₂O₄₀), or combinations thereof. In some embodiments, the chemical reducing agents include vanadium (II) sulfate, chromium (II) chloride, or combinations thereof.

Some aspects of the present disclosure are directed to a method for indirect reduction of chalcopyrite including providing a composition including a concentration of chalcopyrite, contacting the composition with an acidic aqueous solution including one or more acids and one or more chemical reducing agents, wherein the one or more acids include sulfuric acid, hydrochloric acid, or combinations thereof, and wherein the one or more chemical reducing agents include vanadium (II) ions, compounds including vanadium (II) ions, chromium (II) ions, compounds including chromium (II) ions, tungstozincic acid (H₆ZnW₁₂O₄₀), or combinations thereof, reacting the chalcopyrite with the chemical reducing agents to reduce at least a portion of the copper included therein, separating a solids reaction product stream, a liquid reaction product stream, and a gaseous reaction product stream, providing the oxidized chemical reducing agent to an electrochemical device, reducing the oxidized chemical reducing agent at the electrochemical device to a recycled chemical reducing agent, contacting the recycled chemical reducing agent with the composition, treating the gaseous reaction product stream with a concentration of ferric iron to generate a sulfur product and a concentration of ferrous iron, recycling the ferrous iron to the electrochemical device, contacting the solids reaction product stream with one or more acids to produce a dissolved copper product stream, and electrowinning the dissolved copper product stream to isolate a copper product and a recycled acid.

In some embodiments, the solids reaction product stream includes copper, copper compounds, or combinations thereof, the liquid reaction product stream includes oxidized chemical reducing agent, and the gaseous reaction product stream includes H₂S. In some embodiments, the acidic aqueous solution has a concentration of about 0.01M to about 10 M of reducing agent.

Some aspects of the present disclosure are directed to a system for producing a copper product from a copper concentrate. In some embodiments, the system includes a source of copper concentrate, a reduction reactor in communication with the source of copper concentrate, a solid phase product outlet stream in communication with the first product outlet, a dissolution reactor in communication with one or more acid inlet streams and the solid phase product outlet stream, the dissolution reactor producing a dissolved copper product stream, and a copper isolation electrowinning reactor in fluid communication with the dissolved copper product stream, the copper isolation electrowinning reactor producing a copper product and a recycled acid stream in fluid communication with the dissolution reactor.

In some embodiments, the reduction reactor includes an acidic aqueous solution including one or more chemical reducing agents and at least a first product outlet. In some embodiments, the copper concentrate includes chalcopyrite. In some embodiments, the chemical reducing agents include vanadium (II) ions, compounds including vanadium (II) ions, chromium (II) ions, compounds including chromium (II) ions, tungstozincic acid (H₆ZnW₁₂O₄₀), or combinations thereof. In some embodiments, the chemical reducing agents include vanadium (II) sulfate, chromium (II) chloride, or combinations thereof. In some embodiments, the acid inlet stream includes a concentration of iron (III) sulfate, sulfuric acid, or combinations thereof.

In some embodiments, the reduction reactor includes a second product outlet. In some embodiments, the system includes a liquid phase product outlet stream in fluid communication with the second product outlet, the liquid phase product stream including oxidized chemical reducing agent, an electrochemical device in fluid communication with the liquid phase outlet stream, and a recycled chemical reducing agent stream produced by the electrochemical device and in fluid communication with the reduction reactor. In some embodiments, the reduction reactor includes a third product outlet. In some embodiments, the system includes a gaseous phase product outlet stream in fluid communication with the third product outlet, the gaseous phase product outlet stream including hydrogen sulfide, a gaseous treatment reactor in fluid communication with the gaseous phase product outlet stream, a ferric iron feedstream provided from the electrochemical device to the gaseous treatment reactor, a ferrous iron feedstream provided from the gaseous treatment reactor to the electrochemical device, and an elemental sulfur effluent stream.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a chart of a method of producing a copper product from a copper concentrate according to some embodiments of the present disclosure;

FIG. 2 is a schematic representation of a system of producing a copper product from a copper concentrate according to some embodiments of the present disclosure;

FIG. 3 portrays a graph of the percent of Fe²⁺ released from chalcopyrite (CuFeS₂) during the reaction between 1M VSO₄, 4M H₂SO₄, and 39 g/L of concentrate and direct reduction in 1MH₂SO₄;

FIG. 4 portrays a graph of x-ray diffraction (XRD) results for mineral products after 60 minutes of reaction between 1M VSO₄, 4M H₂SO₄, and various loadings of CuFeS₂ concentrate;

FIG. 5 portrays a graph of XRD results for mineral products after 60 minutes of reaction between 1M VSO₄, 4M H₂SO₄, and various loadings of CuFeS₂ concentrate;

FIG. 6A depicts pictures of mineral products after 60 minutes of reaction between 1M VSO₄, 4M H₂SO₄, and various loadings of CuFeS₂ concentrate;

FIG. 6B portrays scanning electron microscopy-energy dispersive X-ray spectroscopy (SEM-EDS) results of mineral products after 60 minutes of reaction between 1M VSO₄, 4M H₂SO₄, and various loadings of CuFeS₂ concentrate;

FIGS. 6C-6D portray XRD spectra for mineral products after 60 minutes of reaction between 1M VSO₄, 4M H₂SO₄, and various loadings of CuFeS₂ concentrate;

FIG. 7 portrays a graph of XRD results for mineral products after 60 minutes of reaction between 1M VSO₄, 39 g/L CuFeS₂ concentrate, and various initial concentrations of H₂SO₄;

FIG. 8A portrays a graph of the release of Fe²⁺ ions to solution during the progression of the reaction between 1M VSO₄, 4M H₂SO₄, and various loadings of CuFeS₂ concentrate;

FIG. 8B portrays a graph of the extraction of Cu²⁺ from mineral products by a solution comprising 1M H₂SO₄ and 0.5M Fe₂(SO₄)₃ subsequent to the reaction between 1M VSO₄, 4M H₂SO₄, and various loadings of CuFeS₂ concentrate;

FIG. 9A portrays a graph of the release of Fe²⁺ ions to solution during the progression of the reaction between 1M VSO₄, 39 g/L CuFeS₂ concentrate, and various initial concentrations of H₂SO₄;

FIG. 9B portrays a graph of the extraction of Cu²⁺ from mineral products by a solution comprising 1M H₂SO₄ and 0.5M Fe₂(SO₄)₃ subsequent to the reaction between 1M VSO₄, 39 g/L CuFeS₂ concentrate, and various initial concentrations of H₂SO₄;

FIG. 10 depicts pictures of the reaction between 1M CrCl₂, 4M HCl and 78 g/L of the CuFeS₂ concentrate at a) 0 s, b) 2 s, c) 3 s, d) 5 s, and e) 1 min;

FIG. 11A portrays a graph of the release of Fe²⁺ ions to solution during the progression of the reaction between 1M CrCl₂, 4M HCl, and various loadings of CuFeS₂ concentrate;

FIG. 11B portrays a graph of the release of Fe²⁺ ions to solution during the progression of the reaction between 1M CrCl₂, 39 g/L CuFeS₂ concentrate, and various initial concentrations of HCl;

FIG. 12 depicts optical microscopy images of the mineral products after reaction between various chalcopyrite concentrate loadings, 1M CrCl₂, and 4M HCl for 60 minutes;

FIG. 13 portrays a graph of XRD results for mineral products after reaction between various chalcopyrite concentrate loadings, 1M CrCl₂, and 4M HCl for 60 minutes;

FIG. 14 portrays a graph of XRD results for mineral products after reaction between 39 g/L of the chalcopyrite concentrate with 1M CrCl₂ and various initial concentrations of HCl for 60 minutes;

FIG. 15 depicts SEM images of mineral products after reaction with 1M CrCl₂ and 4M HCl for 60 minutes;

FIG. 16 portrays a graph of EDS results for the mineral products after reaction with 1M CrCl₂ and 4M HCl for 60 minutes;

FIG. 17A portrays a graph of XPS results for mineral products after reaction with 1M CrCl₂ and 4M HCl for 60 minutes for Cu;

FIG. 17B portrays a graph of XPS results for mineral products after reaction with 1M CrCl₂ and 4M HCl for 60 minutes for Cl;

FIG. 18 portrays a graph showing extraction of Cu²⁺ from mineral products by 0.5M Fe₂(SO₄)₃ subsequent to the reaction between 1M CrCl₂, 4M HCl, and various loadings of CuFeS₂ concentrate, and further between 1M CrCl₂, 39 g/L CuFeS₂ concentrate, and various initial concentrations of HCl; and

FIG. 19 portrays a graph summarizing the energy requirements for various metallurgical processes.

### DESCRIPTION

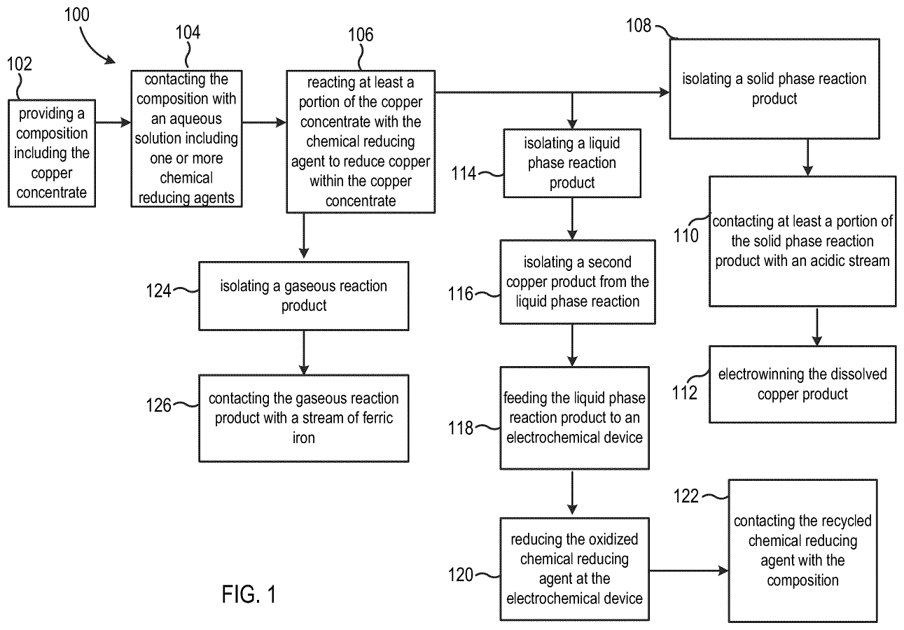

Referring now to FIG. 1, some embodiments of the present disclosure are directed to a method 100 of producing a copper product from a copper concentrate. As used herein, the term “copper concentrate” refers to a composition including a concentration of copper, the extraction of which is desired. In some embodiments, the copper concentrate is a copper-containing mineral or combination of copper-containing minerals. In some embodiments, the copper concentrate is naturally occurring. In some embodiments, the copper concentrate includes a concentration of chalcopyrite. In some embodiments, the copper concentrate is man-made. In some embodiments, the copper concentrate is a waste product, e.g., from an industrial process. By way of example, certain mining processes produce waste products that include copper, but may have an arsenic content that is too high or an actual copper content that is too low to be processed by traditional processes for the purpose of isolating the copper component. However, the systems of the methods of the present disclosure are capable of extracting the copper component even from these traditionally untapped sources of copper.

Still referring to FIG. 1, some embodiments of the present disclosure include the production of a copper product from a copper concentrate via indirect reduction of the concentrate, e.g., from chalcopyrite. The reductive treatment processes consistent with the present disclosure are in contrast to the oxidative treatment more commonly pursued in the literature. At 102, a composition including the copper concentrate is provided. In some embodiments, the composition is provided to any suitable reaction vessel capable of containing the chemical reactions described below with respect to the various embodiments of the present disclosure. At 104, the composition is contacted with an aqueous solution including one or more chemical reducing agents. In some embodiments, the reducing agent is configured to reduce copper within the copper concentrate. In some embodiments, the reducing agent is also configured to be regenerated following oxidation via one or more electrochemical processes. In some embodiments, chemical reducing agents include reducing ions, compounds including the reducing ions, or combination thereof. In some embodiments, the chemical reducing agents include vanadium (II) ions, compounds including vanadium (II) ions, chromium (II) ions, compounds including chromium (II) ions, or combinations thereof. In some embodiments, the chemical reducing agents include vanadium (II) sulfate, chromium (II) chloride, tungstozincic acid (H₆ZnW₁₂O₄₀), or combinations thereof. In some embodiments, the aqueous solution has a concentration of about 0.01M to about 10 M of reducing agent.

In some embodiments, the aqueous solution is acidic. In some embodiments, the aqueous solution includes one or more acids. In some embodiments, the acids include sulfuric acid, hydrochloric acid, or combinations thereof. In some embodiments, the reaction vessel also includes one or more inert species, such as FeS₂, silicates, other materials, or combinations thereof.

At 106, at least a portion of the copper concentrate is reacted with the chemical reducing agent to reduce copper within the copper concentrate. Without wishing to be bound by theory, reactions between the aqueous solution with reducing agent and the copper concentration are provided below. In these exemplary embodiments, chalcopyrite is chemically reduced by the reducing agents. Reactions 3 and 4 show reactions between CuFeS₂, VSO₄, and H₂SO₄. The products Cu₂S and Cu⁰ are thermodynamically stable at low pH and reductive conditions. These reactions resemble Reactions 1 and 2 above but use the V²⁺ ion as an electron mediator to improve the electrochemical performance.

2CuFeS₂+6H⁺+2V²⁺→Cu₂S+2Fe²⁺+3H₂S+2V³⁺ [3]

Cu₂S+2H⁺+2V²⁺→2Cu+H₂S+2V³⁺ [4]

A violent reaction was observed upon adding CuFeS₂ concentrate to the acidic V²⁺ solution. The rapid release of a gaseous species is consistent with the generation of H₂S shown in Reactions 3 and 4. The liquid phase samples were measured with GC-MS to confirm the presence of dissolved H₂S.

Reaction 5 shows a reaction between CrCl₂ and HCl.

CuFeS₂+4H⁺+Cr²⁺→Cu⁺+Fe²⁺+2H₂S+Cr³⁺ [5]

Again, a violent reaction was observed upon adding the CuFeS₂ concentrate to the solution of CrCl₂ and HCl, consistent with the evolution of gaseous species predicted in Reaction 5. Although the cost of these reducing agents is high relative to copper, processes can be leveraged to efficiently regenerate the reducing agent, e.g., a vanadium redox flow battery, or similar electrochemical cell to regenerate V²⁺ at high current densities. In some embodiments, the reduction reactions occur homogeneously, e.g., within the entire reaction vessel or across the entirety of the copper concentrate. As evidenced by Reactions 3-5 above, reacting step 106 generates a copper product that can be isolated and used, or further processed for use, in whatever downstream process desired by the user. In some embodiments, the copper product is elemental copper. In some embodiments, the copper product is present as a copper-containing compound, which can be subsequently processed to isolate elemental copper therefrom, as will be discussed in greater detail below. In some embodiments, at least a portion of the copper product precipitates out of solution during or after reacting step 106. In some embodiments, at least a portion of the copper product precipitates out of solution in the reaction vessel. In some embodiments, at least a portion of the copper product precipitates out of solution as elemental copper. In some embodiments, at least a portion of the copper product precipitates out of solution as a copper compound. In some embodiments, at least a portion of the copper product remains in solution.

At 108, a solid phase reaction product is isolated. In some embodiments, the solid phase reaction product includes one or more species that precipitated out of solution during or in response to step 106, e.g., the copper product. As discussed above, in some embodiments, the solid phase reaction product includes solid elemental copper, solid copper-containing compounds, or combinations thereof. In some embodiments, the solid phase reaction product includes at least a portion of the copper product. In some embodiments, the solid phase reaction product includes all of the copper product. In some embodiments, at 110, at least a portion of the solid phase reaction product is contacted with an acidic stream. The acidic stream is effective to solubilize the copper product in the solid phase reaction product and produce a dissolved copper product. In some embodiments, the acidic stream include one or more acids. In some embodiments, the acidic stream includes a concentration of iron (III) sulfate, sulfuric acid, or combinations thereof. In some embodiments, the solid phase reaction product includes mineral inerts. Without wishing to be bound by theory, the inerts mostly include pyrite and silicates, although there may be trace amounts of rhenium- and arsenic-including compounds. It may be economically advantageous to recover rhenium-including inerts for rhenium production, and it may be environmentally advantageous to recover arsenic-including inerts for their conversion to benign forms.

At 112, the dissolved copper product is electrowinned, e.g., is provided to an electrowinning reactor, to isolate the copper product and produce a recycled acid. In some embodiments, the recycled acid is recycled for use during contacting step 110.

Still referring to FIG. 1, at 114, a liquid phase reaction product is isolated. In some embodiments, the liquid phase reaction product is isolated 114 as a result of the solid phase reaction product being isolated at step 108 as discussed above. In some embodiments, the liquid phase reaction product includes an oxidized chemical reducing agent, e.g., V³⁺ and/or Cr³⁺. In some embodiments, the liquid phase also includes Fe²⁺ ions in sulfuric acid. In some embodiments, the high solubility of oxidized reducing agent may be leveraged for its separation from Fe²⁺. In some embodiments, a biological reactor is used to oxidize V³⁺ and Fe²⁺ and hence facilitate their separation. In some embodiments, at 116, a second copper product is isolated from the liquid phase reaction product by any suitable means.

At 118, the liquid phase reaction product is fed to an electrochemical device. At 120, the oxidized chemical reducing agent is reduced at the electrochemical device. In some embodiments, the electrochemical device includes a concentration of ferrous iron or other reactant effective to help reduce the oxidized chemical reducing agent. In some embodiments, the oxidizing chemical reducing agent is reduced to a recycled chemical reducing agent. Without wishing to be bound by theory, in an exemplary embodiment, the cathodic reaction of the electrochemical device is given by Reaction 6, while the anodic reaction is given by Reaction 7.

V³⁺+e⁻→V²⁺ [6]

Fe²⁺→Fe³⁺+e⁻ [7]

Membrane crossover of the vanadium species may be mitigated by the application of high current densities, which are also desirable to achieve high reaction rates. Crossover of the iron species may lower the efficiency of the electrochemical cell but may not lead to long-term damage due to the downstream separation of iron. At 122, the recycled chemical reducing agent is contacted with the composition, e.g., at the reaction vessel.

Still referring to FIG. 1, at 124, a gaseous reaction product is isolated. In some embodiments, the gaseous phase reaction product is isolated 124 as a result of the solid phase reaction product being isolated at step 108, the liquid phase product being isolated at step 114, or combinations thereof. In some embodiments, the gaseous reaction product includes hydrogen sulfide. In some embodiments, at 126, the gaseous reaction product is contacted with a stream of ferric iron. Without wishing to be bound by theory, in an exemplary embodiment, the gaseous reaction product is treated with ferric ions for the recovery of protons by Reaction 8 below.

2Fe³⁺+H₂S→2Fe²⁺+2H⁺+S⁰ [8]

In some embodiments, the protons produced by this reaction are transported across the separator of an electrochemical device, and are thus recovered. In some embodiments, the stream of ferric iron is provided from the electrochemical device. In some embodiments, contacting step 126 forms a ferrous iron effluent stream and an elemental sulfur effluent stream. In some embodiments, the ferrous iron effluent stream is recycled to the electrochemical device. In some embodiments, sulfur product in the elemental sulfur effluent stream is recycled for use in one or more downstream processes. In some embodiments, sulfur product in the elemental sulfur effluent stream is discarded.

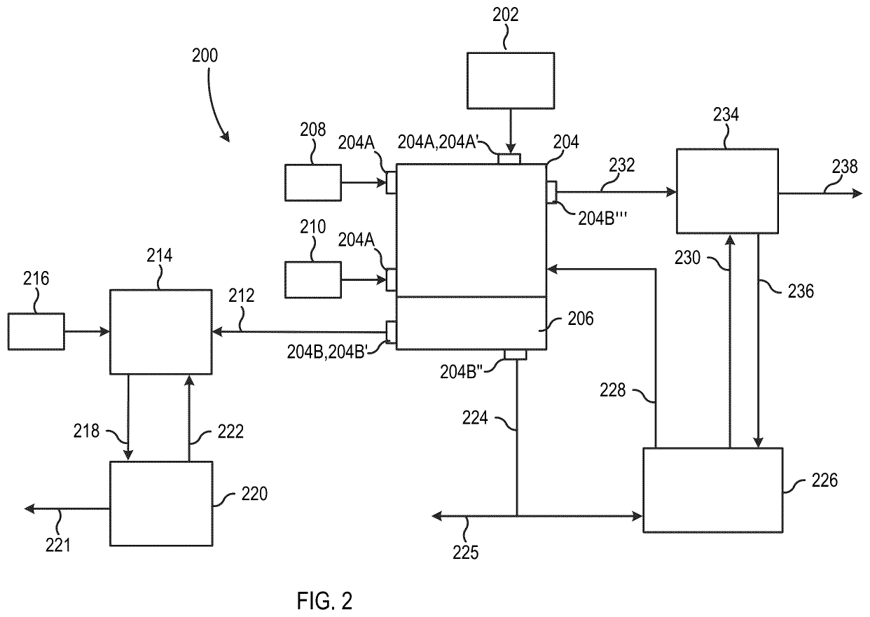

Referring now to FIG. 2, some embodiments of the present disclosure are directed to a system 200 for producing a copper product from a copper concentrate. In some embodiments, system 200 includes a source 202 of copper concentrate. As discussed above, in some embodiments, the copper concentrate from the source is naturally occurring, man-made, or combinations thereof. In some embodiments, the copper concentrate includes a concentration of chalcopyrite, a waste product, e.g., from an industrial process, or combinations thereof.

In some embodiments, system 200 includes a reduction reactor 204, e.g., the reaction vessel described above with respect to method 100. In some embodiments, reduction reactor has one or more inputs 204A and one or more outputs 204B. In some embodiments, system 200 is configured to provide copper concentrate from source 202 to reduction reactor 204. In some embodiments, reduction reactor 204 is in communication with source 202 of copper concentrate, e.g., via input 204A′. In some embodiments, reduction reactor 204 includes an aqueous solution 206. As discussed above, in some embodiments, aqueous solution 206 includes one or more chemical reducing agents. In some embodiments, chemical reducing agents include reducing ions, compounds including the reducing ions, or combination thereof. In some embodiments, the chemical reducing agents include vanadium (II) ions, compounds including vanadium (II) ions, chromium (II) ions, compounds including chromium (II) ions, or combinations thereof. In some embodiments, the chemical reducing agents include vanadium (II) sulfate, chromium (II) chloride, tungstozincic acid (H₆ZnW₁₂O₄₀), or combinations thereof. In some embodiments, aqueous solution 206 has a concentration of about 0.01M to about 10M of reducing agent. In some embodiments, aqueous solution 206 is acidic. In some embodiments, the aqueous solution includes one or more acids. In some embodiments, the acids include sulfuric acid, hydrochloric acid, or combinations thereof.

In some embodiments, system 200 is configured to provide chemical reducing agents to reduction reactor 204. In some embodiments, chemical reducing agents are provided from a source 208 of chemical reducing agents, e.g., at an input 204A. In some embodiments, at least a portion of the chemical reducing agent in aqueous solution 206 is in the form of a recycle stream generated by system 200 itself via one or more other components, as will be discussed in greater detail below. In some embodiments, system 200 is configured to provide one or more acids to reduction reactor 204. In some embodiments, the acids are provided from a source 210 of acids, e.g., at an input 204A. In some embodiments, at least a portion of the acid in aqueous solution 206 is in the form of a recycle stream provided by system 200 itself via one or more other components.

As discussed above, reduction reactor 204 is configured to react at least a portion of the copper concentrate with the chemical reducing agent to reduce copper within the copper concentrate and separate a copper product from the copper concentrate. In some embodiments, at least a portion of the copper product precipitates out of solution in reduction reactor 204. In some embodiments, at least a portion of the copper product precipitates out of solution as elemental copper. In some embodiments, at least a portion of the copper product precipitates out of solution as a copper compound. In some embodiments, at least a portion of the copper product remains in solution.

Still referring to FIG. 2, system 200 includes a solid phase product outlet stream 212. In some embodiments, solid phase product outlet stream 212 is in communication with and removed from reduction reactor 204 by an outlet, e.g., first product outlet 204B′. As discussed above, in some embodiments, solid phase product outlet stream 212 includes solid elemental copper, solid copper-containing compounds, or combinations thereof. In some embodiments, solid phase product outlet stream 212 includes at least a portion of the copper product. In some embodiments, solid phase product outlet stream 212 includes all of the copper product.

In some embodiments, the solid phase reaction product stream 212 is provided to a dissolution reactor 214. In some embodiments, system 200 is configured to provide one or more acids to dissolution reactor 214. In some embodiments, dissolution reactor 214 is in communication with one or more acid inlet streams 216. As discussed above, at least a portion of solid phase product outlet stream 212 is contacted with acid, e.g., from acid inlet stream 216. The acid is effective to solubilize the copper product in solid phase product outlet stream 212 and produce a dissolved copper product stream 218. In some embodiments, acid inlet stream 216 includes a concentration of iron (III) sulfate, sulfuric acid, or combinations thereof. In some embodiments, dissolved copper product stream 218 is sent to an electrowinning reactor 220, which produces and/or separates a copper product 221 and a recycled acid stream 222. In some embodiments, at least a portion of recycled acid stream 222 is fed back to dissolution reactor 214 for use in the dissolution of solid phase product outlet stream 212 in that reactor.

Still referring to FIG. 2, system 200 includes a liquid phase product outlet stream 224. In some embodiments, liquid phase product outlet stream 224 is in communication with and removed from reduction reactor 204 by an outlet, e.g., second product outlet 204B″. As discussed above, in some embodiments, liquid phase product outlet stream 224 includes oxidized chemical reducing agent, e.g., V³⁺ and/or Cr³⁺. In some embodiments, the liquid phase also includes Fe²⁺ ions in sulfuric acid. In some embodiments, iron (II) ion species, a second copper product, e.g., dissolved copper product, or combinations thereof, are removed from liquid phase product outlet stream via one or more streams 225. In some embodiments, the high solubility of oxidized reducing agent may be leveraged for its separation from Fe²⁺. In some embodiments, liquid phase product outlet stream 224 includes a concentration of dissolved copper product, which can be isolated and recovered, e.g., via an electrowinning process.

In some embodiments, at least a portion of liquid phase product outlet stream 224 is fed to an electrochemical device 226. As discussed above, electrochemical device 226 includes a concentration of ferrous iron or other reactant effective to help reduce the oxidized chemical reducing agent. In some embodiments, the oxidized chemical reducing agent is reduced to a recycled chemical reducing agent and removed from electrochemical device 226 as a recycled chemical reducing agent stream 228. In some embodiments, recycled chemical reducing agent stream 228 is provided back to reduction reactor 204, e.g., at input 204A″. In some embodiments, at least a portion of the ferrous iron is oxidized and removed as ferric iron feed stream 230, as will be discussed below.

Still referring to FIG. 2, system 200 includes a gaseous phase product outlet stream 232. In some embodiments, gaseous phase product outlet stream 232 is in communication with and removed from reduction reactor 204 by an outlet, e.g., third product outlet 204B′″. As discussed above, in some embodiments, gaseous phase product outlet stream 232 includes hydrogen sulfide gas. In some embodiments, ferric iron feed stream 230 and gaseous product outlet stream 232 are combined in a gaseous treatment reactor 234. The reaction between stream 230 and stream 232 forms a ferrous iron effluent stream 236 and an elemental sulfur effluent stream 238. In some embodiments, ferrous iron effluent stream 236 is recycled to electrochemical device 226 for use in reducing oxidized chemical reducing agent. In some embodiments, sulfur product in elemental sulfur effluent stream 238 is recycled for use in one or more downstream processes. In some embodiments, sulfur product in elemental sulfur effluent stream 238 is discarded.

Systems consistent with embodiments of the present disclosure include any additional miscellaneous components, e.g., conduits, power supplies, controllers, product collection reservoirs, etc., to facilitate the reduction of chalcopyrite and isolation of copper product, as will be clear to those of skill in the art.

### Examples

In an exemplary embodiment, a sample of chalcopyrite mineral concentrate was provided. The sample was analyzed with energy dispersion X-ray diffraction and found to have the composition according to Table 2 below:

TABLE 2
Mineralogy of chalcopyrite concentrate

| Mineral | Chemical Formula | Percent |
|---|---|---|
| Chalcopyrite | CuFeS₂ | 78.3 |
| Pyrite | FeS₂ | 12.9 |
| K-feldspar | KAISi₃O₈ | 2.9 |
| Plagioclase | NaAlSi₃O₈ | 2.9 |
| Quartz | SiO₂ | 2.2 |
| Molybdenite | MoS₂ | 0.85 |

In addition to the concentrate shown in Table 2, three other versions of concentrate were provided with varying quantities of copper and other inerts. The processes of the present disclosure was determined to be compatible with concentrates of a wide range in purities. The CuFeS₂ concentrate was sieved (−140+270 mesh) to confine the particle size to be within 53-106 μm. The concentrate was subsequently rinsed with DI water and 1M H₂SO₄ to remove any soluble iron and copper ions generated during natural concentrate oxidation occurring in transport and storage.

In a first exemplary embodiment, CuFeS₂ concentrate pulp densities of 39, 78, 117, or 234 g/L were added to a 250 mL Erlenmeyer flask containing 25 mL of a solution including 1M VSO₄ and 4M H₂SO₄. For other experiments, a CuFeS₂ concentrate pulp density of 39 g/L was added to a solution including 1M VSO₄ and various H₂SO₄ concentrations. The reaction was conducted in a fume hood due to the rapid release of H₂S gas. Liquid phase 100 μL samples were taken at time points of 0, 5, 10, 20, 40, and 60 minutes, which were subsequently diluted for the measurement of Fe²⁺ and Cu⁺ content. After the reduction, the mineral particles were filtered from solution and allowed to air dry prior to characterization.

An iCE 3300 AAS was used to measure the release of iron and copper ions into solution from CuFeS₂ during its reduction. The characteristic wavelengths for the iron and copper measurements were 248.3 nm and 324.8 nm, respectively. Standards ranging from 0-4 ppm were measured immediately before the samples to construct linear (R2>0.995) calibration curves.

A PANalytical XPert3 Powder XRD was used to measure the bulk mineral phase of the reaction products. The XRD was operated with filtered Empyrean Cu Ka radiation (k=0.15418 nm), a tube voltage of 45 kV, and a current of 40 mA. The mineral products were placed on a silicon crystal zero-diffraction plate (MTI Corporation) and were adhered in place with Apiezon grease. The samples were scanned continuously in the range of 10-100° with a step size of 0.0065° on a spinning plate with a revolution time of 2.0 s. A PIXcellD detector was used to record the peak intensity for the subsequent analysis of the mineral composition.

A Zeiss Sigma VP SEM was used to capture images of the mineral products after reaction. The SEM-EDS analysis was operated at an accelerating potential of 6 kV and base pressure of approximately 1×10⁻⁵ torr. Samples were supported on carbon tape and were coated with gold using a Cressington 108 Auto Sputter Coater. The sputtering was conducted under argon gas flow with 0.1 mbar of pressure for 20 s to obtain a 1 nm coating of AuPd. A Bruker XFlash Detector was used for EDS analysis to analyze elemental composition.

A sample of the mineral products was digested in aqua regia for copper extraction, and an equivalent sample of the mineral products was leached in a solution including 0.5M Fe₂(SO₄)₃ in 1M H₂SO₄. The percent of copper released was determined by the ratio of copper extracted by the two leachants.

The H₂S gas was rapidly released and qualitatively measured with a Sensorcon detector. The release of gas ensued immediately upon the addition of the concentrate and concluded within minutes of reaction time. Liquid phase samples were measured with gas chromatography-mass spectroscopy (GC-MS) to confirm the presence of dissolved H₂S, while no other gases were detected. The H₂S gas may be oxidized to innocuous S⁰ in an industrial process.

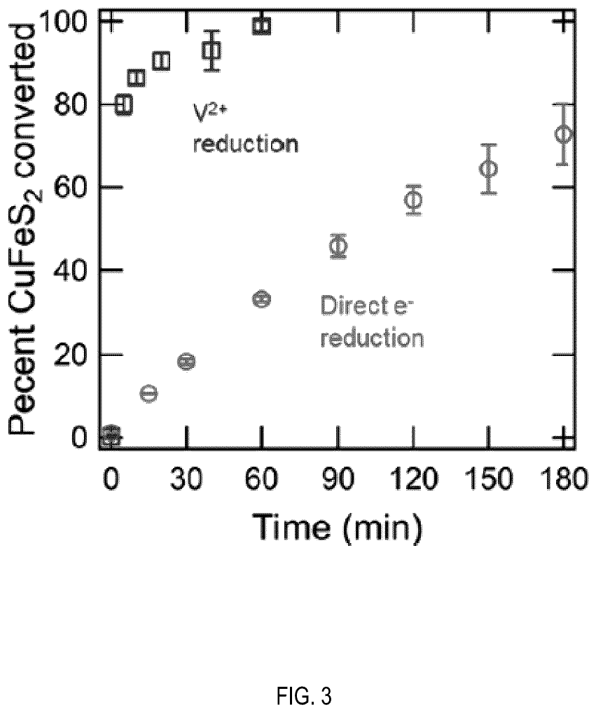

FIG. 3 shows the percent of Fe²⁺ released from CuFeS₂ concentrate during its direct electrochemical reduction (Reactions 1-2) and its reduction by VSO₄ (Reactions 3-4). It was experimentally validated that Fe²⁺ within the concentrate was inert, and therefore the measurement of Fe²⁺ was a suitable proxy for CuFeS₂ conversion. The figure demonstrates that the use of an electron mediator is kinetically advantageous to the direct electrochemical reduction of CuFeS₂ concentrate. VSO₄ enables 100% release of Fe²⁺ from CuFeS₂ concentrate within 60 minutes despite the relative high concentrate loading of 39 g/L. The direct electrochemical reduction requires extended durations to achieve complete conversion of concentrate due to the proclivity of the hydrogen evolution reaction to take place for slurry electrodes. The direct electrochemical reduction results shown in FIG. 3 utilized the same experimental procedure denoted in the literature with an applied current density of 10 mA/cm2.

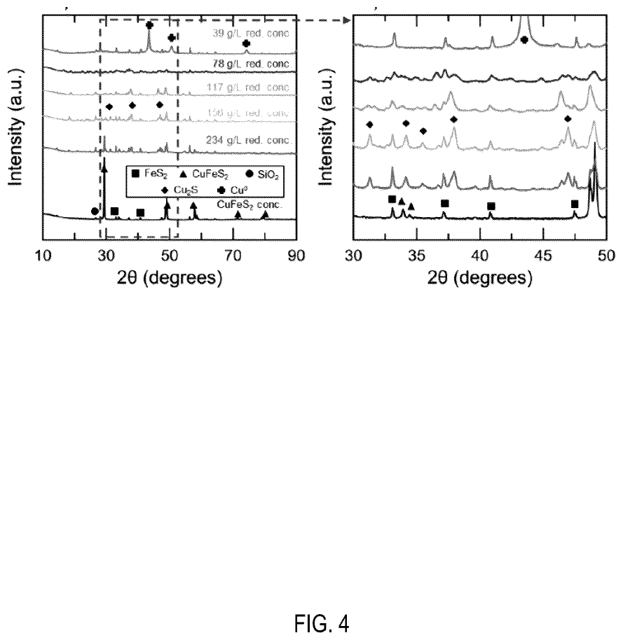

FIG. 4 shows the XRD characterization of the mineral products immediately following the reductive leaching by VSO₄. The predominant peaks of the unreacted CuFeS₂ concentrate sample correspond to CuFeS₂, FeS₂, and SiO₂, which is consistent with the mineralogy shown in Table 2. The peaks corresponding to CuFeS₂ diminished in the spectra of the reacted mineral products and peaks corresponding to the mineral products emerged. The results show the progression of the copper-containing solids from CuFeS₂ to Cu₂S and Cu⁰, which is consistent with Reactions 3 and 4. The XRD spectra corroborate that FeS₂ and silicates were inert during the reductive leaching by VSO₄.

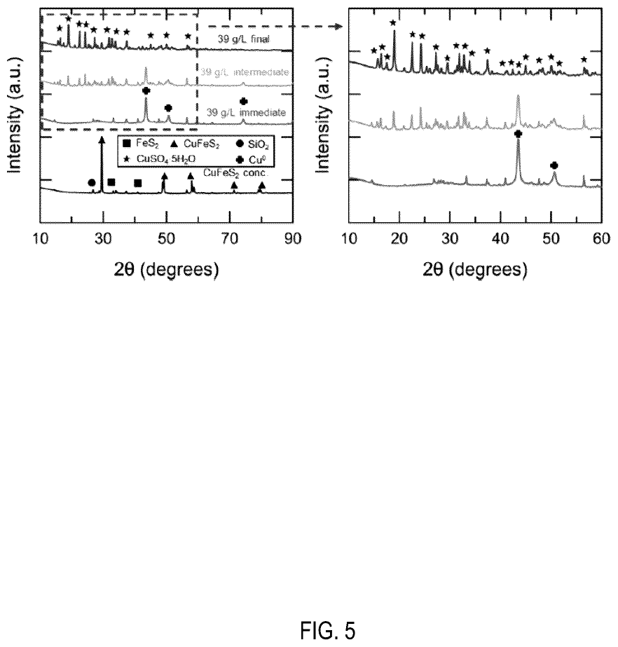

FIG. 5 shows the shift in the mineral products from Cu⁰ to CuSO₄·5H₂O during an air-drying step. Sulfuric acid still coated on the samples reacted with air as shown by Reaction 9 to produce CuSO₄·5H₂O. Without wishing to be bound by theory, it is hypothesized that galvanic interactions between Cu⁰ and FeS₂, studied in iron-containing systems, may also occur in vanadium-containing systems and have a secondary effect.

2Cu⁰+2H₂SO₄+O₂→2CuSO₄+2H₂O [9]

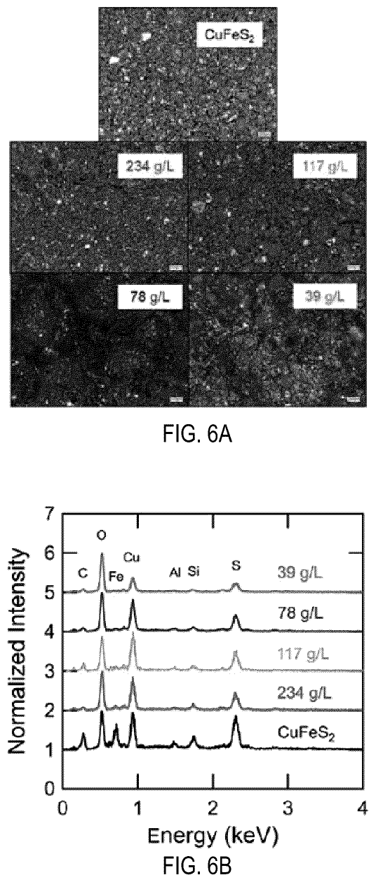

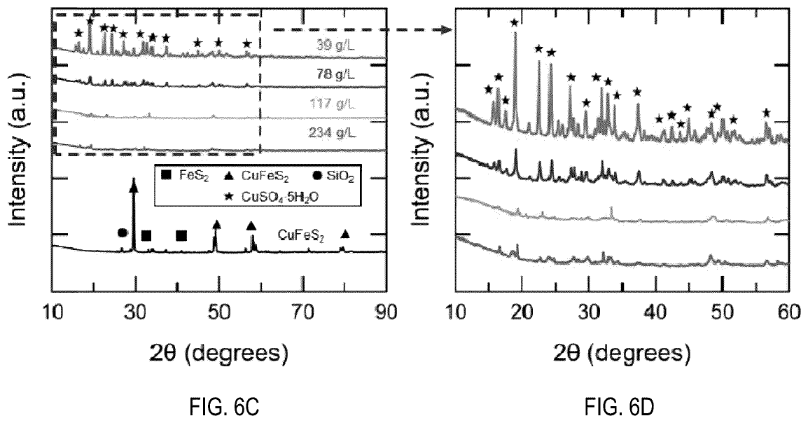

FIGS. 6A-6D show the characterization of the mineral products after 60 minutes of reaction between 1M VSO₄, 4M H₂SO₄, and various loadings of CuFeS₂ concentrate (Reactions 3 and 4 above) and after air-drying (Reaction 9). FIG. 6A shows optical microscopy images of the mineral products, which were obtained with a Keyence VHX-5000 microscope. The appearance of the mineral products differed significantly from the unreacted CuFeS₂ concentrate. The mineral products were blue in appearance, which may be indicative of CuSO₄·5H₂O. FIG. 6B shows the SEM-EDS results of the mineral products after 60 minutes of reaction between 1M VSO₄, 4M H₂SO₄, and various loadings of concentrate. The unreacted chalcopyrite concentrate sample shows peaks corresponding to the characteristic energies of C, 0, Fe, Cu, Al, Si, and S, which is consistent with the mineralogy shown in Table 2. The presence of the C peak is an artifact of placing the samples on carbon tape prior to analysis. The reacted samples show diminishments in the Fe and S peaks due to the release of Fe²¹ ions to solution and the release of H₂S as a gas, respectively. The reacted samples also show diminishments in the Al and Si peaks due to their decreasing mass fractions within the samples. The predominant peaks of the reacted samples are Cu, S, and O, which is consistent with the formation of CuSO₄·5H₂O. The elongation of the O peak within the spectra is consistent with this product. Without wishing to be bound by theory, the absence of a V peak within the indicates that V does not precipitate to the solid phase during the progression of the reaction.

FIG. 6C shows XRD spectra for the mineral products after 60 minutes of reaction between 1M VSO₄, 4M H₂SO₄, and various loadings of concentrate. The predominant peaks of the unreacted CuFeS₂ concentrate sample corresponded to CuFeS₂, FeS₂, and SiO₂, which is consistent with the mineralogy shown in Table 2. The peaks corresponding to CuFeS₂ diminished in the spectra of the reacted mineral products and peaks corresponding to the mineral products emerged. FIG. 6D shows the region of the XRD spectra used to identify the mineral products. The XRD spectra of the mineral products are consistent with the formation of CuSO₄·5H₂O, which is consistent with the SEM-EDS data set.

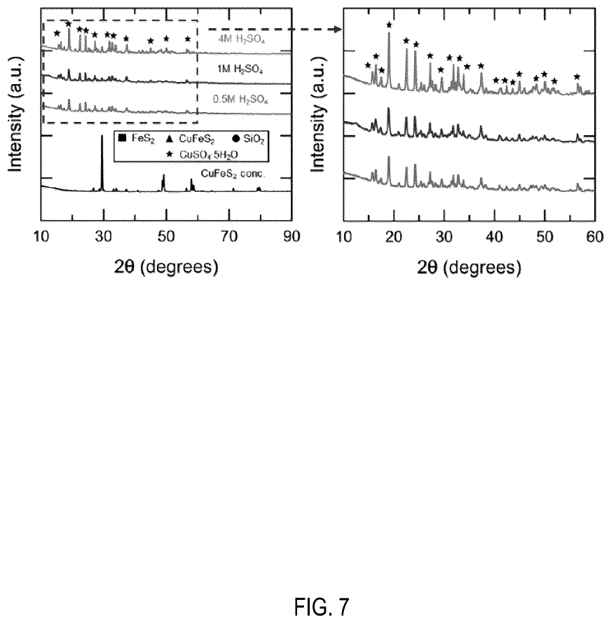

FIG. 7 shows that XRD spectra consistent with CuSO₄·5H₂O was reproducible for experiments conducted between 1M VSO₄, 39 g/L of concentrate, and initial H₂SO₄ concentrations of 0.5M and 1M. The pH of the solution subsequent to the reactions were below one for all of these experiments, indicating that these reactions were not pH limited. No vanadium salt was observed to precipitate from solution for any of these conditions, which indicates that the process has potential for high vanadium recovery and recycle. The pH of these solutions were below one, suggesting that these reactions were not pH limited. Vanadium redox flow batteries (VRFBs) typically operate with H₂SO₄ concentrations ranging from 2-4M, and therefore, a downstream vanadium (II) regeneration step may benefit from relatively high acid concentrations.

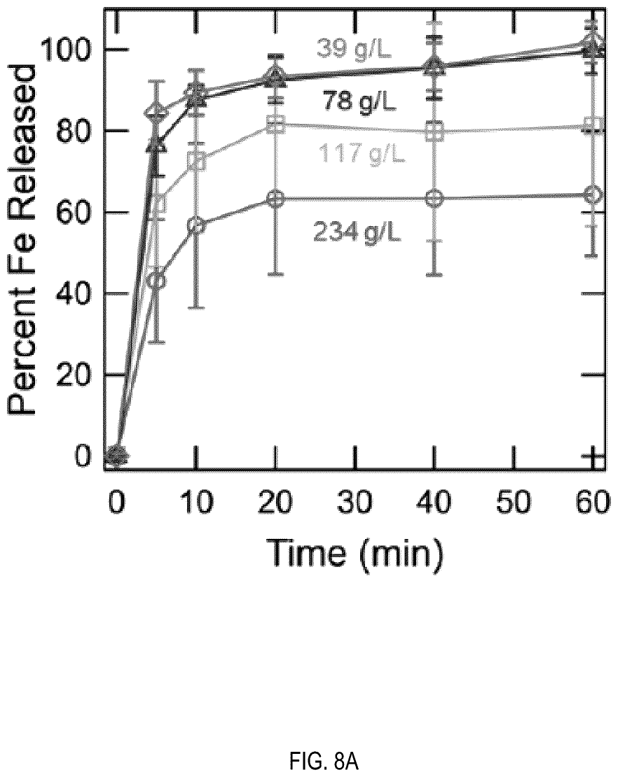

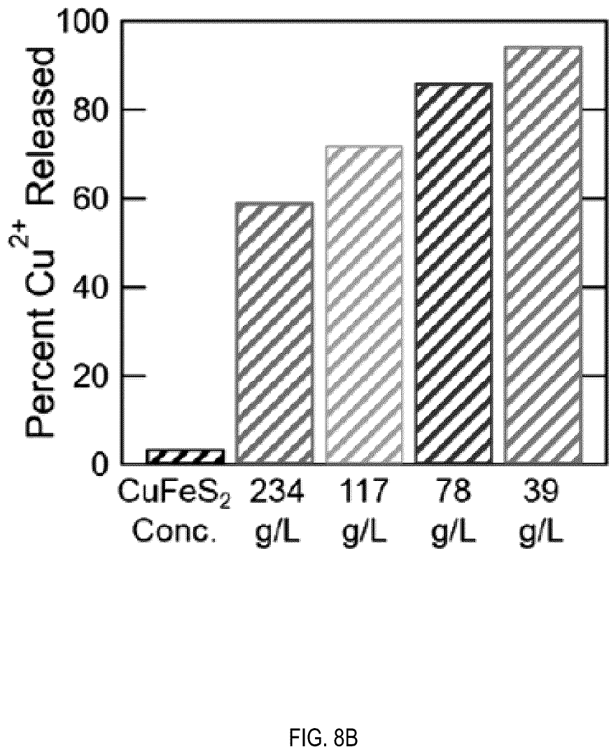

FIG. 8A shows the percent of Fe²⁺ released as a function of time for a slurry including 1M VSO₄, 4M H₂SO₄, and CuFeS₂ concentrate loadings of 39, 78, 117, and 234 g/L. The figure shows that approximately 100% of Fe²⁺ was released from CuFeS₂ during the reduction, which is consistent with Reactions 3 and 4. Without wishing to be bound by theory, the incomplete release of Fe²⁺ for the experiments conducted with concentrate loadings of 117 and 234 g/L suggests the complete utilization of V²⁺.

FIG. 8B shows the results for the subsequent extraction of Cu²⁺ from the mineral products by reaction with a solution including 0.5M Fe₂(SO₄)₃ in 1M H₂SO₄ for 60 minutes. Reaction 10 shows the dissolution of CuSO₄·5H₂O, which was characterized to be the final mineral product for reactions between 1M VSO₄, 4M H₂SO₄ and 39 g/L of chalcopyrite concentrate.

CuSO₄→Cu²⁺+SO₄²⁻ [10]

The results show that virtually all of the Cu²⁺ can be extracted from the 39 g/L mineral products within minutes. The 39 g/L samples were also solubilized in 1M H₂SO₄. The aqueous solution may go to solvent extraction and electrowinning for the production of metallic copper. Without wishing to be bound by theory, the incomplete copper extraction for higher pulp densities is partly related to the incomplete conversion of CuFeS₂ shown by the XRD analysis above. It is shown that virtually no Cu²⁺ is extracted from the CuFeS₂ concentrate, and therefore, the reductive treatment directly leads to the extraction of copper.

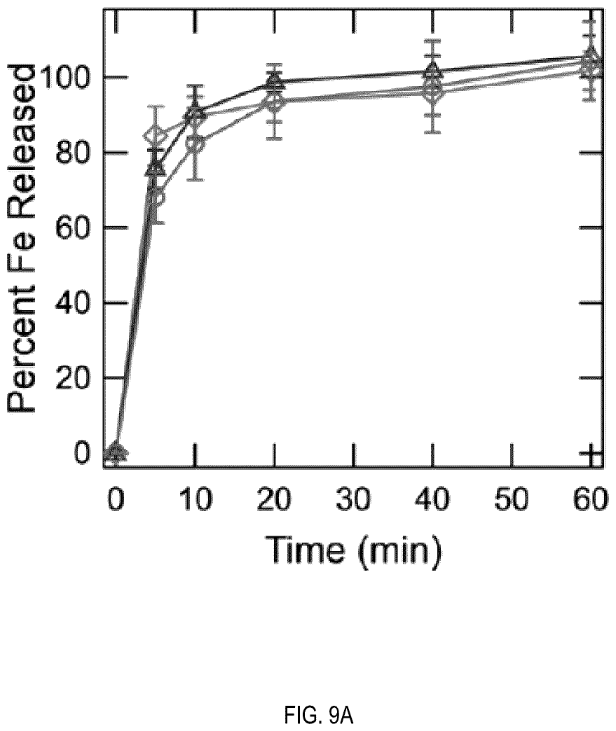

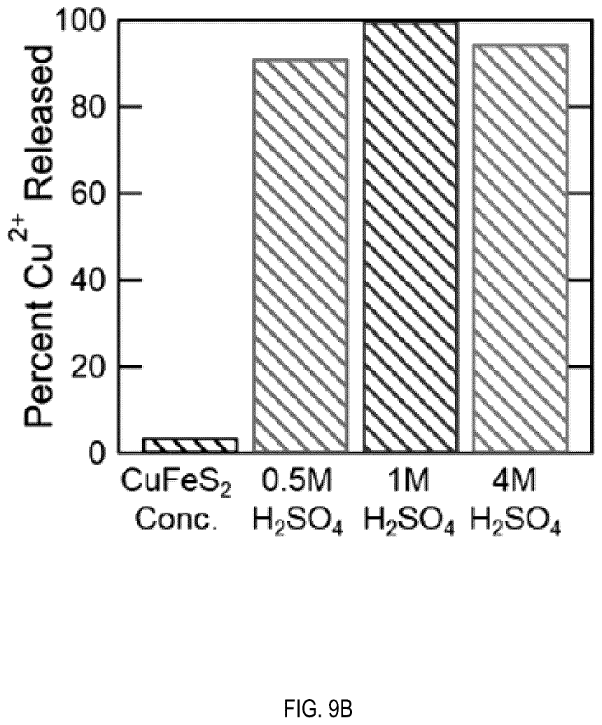

FIG. 9A shows that approximately 100% of Fe²⁺ was released from CuFeS₂ for the concentrate loading of 39 g/L and H₂SO₄ concentrations of 0.5M, 1M, and 4M. FIG. 9B shows the mineral products react completely with a solution including 0.5M Fe₂(SO₄)₃ in 1M H₂SO₄ for the complete recovery of copper. These results indicate that the reduction step may not depend on acid concentration as long as there are a sufficient number of protons available to facilitate the reaction.

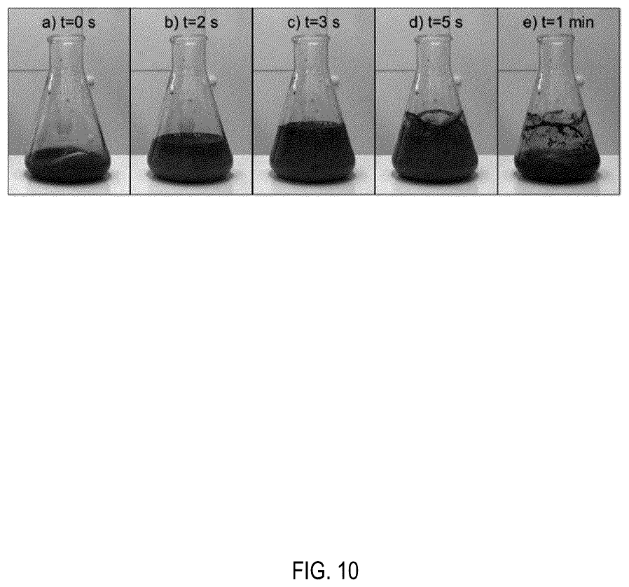

In a second exemplary embodiment, CuFeS₂ concentrate pulp densities of 39, 78, 117, or 234 g/L were added to a 250 mL Erlenmeyer flask containing 25 mL of a solution including 1M CrCl₂ and 4M HCl. For other experiments, a CuFeS₂ concentrate pulp density of 39 g/L was added to a solution including 1M CrCl₂ and various HCl concentrations. Thirdly, for other experiments, a CuFeS₂ concentrate pulp density of 39 g/L was added to a solution including 1M CrCl₂, 4M HCl, and various concentrations of FeCl₂. The reaction was conducted in a fume hood due to the rapid release of H₂S gas, shown in FIG. 10. Liquid phase 100 μL samples were taken at time points of 0, 5, 10, 20, 40, and 60 minutes, which were subsequently diluted for the measurement of Fe²⁺ and Cu⁺ content. After the reduction, the mineral particles were filtered from solution and allowed to air dry prior to characterization.

An iCE 3300 AAS was used to measure the release of Fe²⁺ and Cu⁺ ions into solution from CuFeS₂ during its reduction. The characteristic wavelengths for the iron and copper measurements were 248.3 nm and 324.8 nm, respectively. Standards ranging from 0-4 ppm were measured immediately before the samples to construct linear (R2>0.995) calibration curves.

A PANalytical XPert3 Powder XRD was used to measure the bulk mineral phase of the reaction products. The XRD was operated with filtered Empyrean Cu Ka radiation (k=0.15418 nm), a tube voltage of 45 kV, and a current of 40 mA. The mineral products were placed on a silicon crystal zero-diffraction plate (MTI Corporation) and were adhered in place with Apiezon grease. The samples were scanned continuously in the range of 10-100° with a step size of 0.0065° on a spinning plate with a revolution time of 2.0 s. A PIXcellD detector was used to record the peak intensity for the subsequent analysis of the mineral composition.

A PHI 5500 XPS equipped with an Al x-ray source was used to measure the elemental composition of the reaction product surfaces. The base pressure of the chamber was approximately 1×10⁻⁸ torr. Samples were supported on carbon tape.

A Zeiss Sigma VP SEM was used to capture images of the mineral products after reaction. The SEM-EDS analysis was operated at an accelerating potential of 6 kV and base pressure of approximately 1×10⁻⁵ torr. Samples were supported on carbon tape and were coated with gold using a Cressington 108 Auto Sputter Coater. The sputtering was conducted under argon gas flow with 0.1 mbar of pressure for 20 s to obtain a 1 nm coating of AuPd. A Bruker XFlash Detector was used for EDS analysis to analyze elemental composition.

A sample of the mineral products was digested in aqua regia for complete copper extraction, and an equivalent sample of the mineral products was leached in a solution including 0.5M Fe₂(SO₄)₃ in 1M H₂SO₄. The percent of copper released was determined by the ratio of copper extracted by the two leachants.

FIG. 10 shows pictures of the reaction between 1M CrCl₂, 4M HCl, and 78 g/L CuFeS₂ concentrate after 0, 2, 3, 5, and 60 seconds of reaction time. The pictures show the rapid release of H₂S gas, which was qualitatively measured with a Sensorcon detector. The release of gas ensued immediately upon the addition of the concentrate and concluded within a minute of reaction time. The liquid phase samples were measured with gas chromatography-mass spectroscopy (GC-MS) to confirm the presence of dissolved H₂S for similar experiments.

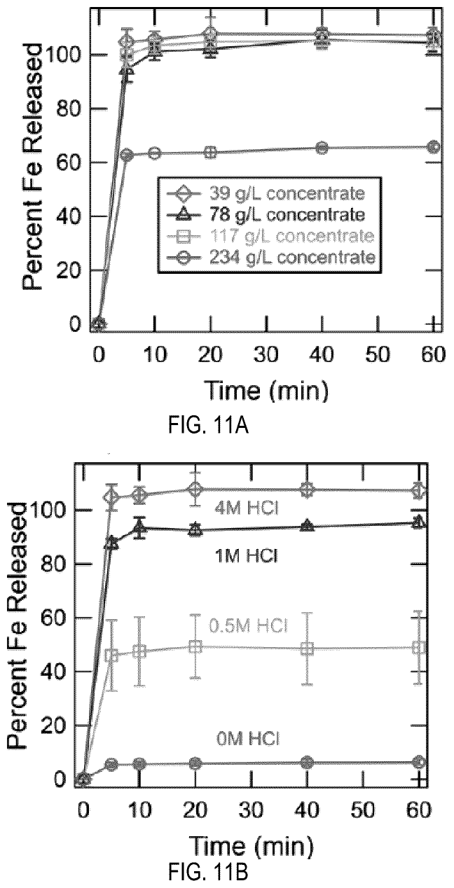

The evolution of gaseous H₂S coincided with the release of Fe²⁺ ions to solution, which is consistent with Reaction 5 above. FIG. 11A shows the percent of Fe²⁺ released as a function of time for a slurry including 1M CrCl₂, 4M HCl, and CuFeS₂ concentrate loadings of 39, 78, 117, and 234 g/L. The reaction kinetics were rapid considering that approximately 100% of Fe²⁺ was released from CuFeS₂ within 5 minutes for the CuFeS₂ concentrate loadings of 39, 78 and 117 g/L. The release of Fe²⁺, however, was limited for the CuFeS₂ concentrate loading of 234 g/L suggesting the complete utilization of Cr²⁺. Without wishing to be bound by theory, measurements of Fe²⁺ release exceeding 100% may indicate a minor error in the estimation of composition shown in Table 2 due to both the error in XRD quantification and the sieving of the concentrate to be within 53-106 m. Experiments were conducted while purging the headspace of the reactor with argon and similar results were observed, indicating that small amount of oxygen present in the system did not oxidize Cr²⁺ to any significant level for the experiments shown. The release of Cu⁺ to solution during the progression of the reaction was measured, but the quantitative results were inconsistent due to the precipitation of the Cu⁺ ion out of solution. The pH of the solutions after the reduction experiments were below zero, indicating that these reactions were not pH limited.

FIG. 11B shows the percent of Fe²⁺ released as a function of time for slurries including 1M CrCl₂, 39 g/L of CuFeS₂ concentrate, and initial HCl concentrations of 0M, 0.5M, 1M, and 4M. The pH of the solution after the reduction step was approximately 2.5 for the slurries with initial HCl concentrations of 0M, 0.5M, and 1M, indicating that these reactions were pH limited. The pH of the solution after the reduction step may be leveraged to facilitate a separation between Fe²⁺ and Cr³⁺, which may be desirable prior to the reduction of Cr³⁺ to Cr²⁺ by an electrolysis unit. These results suggest that the proton has a greater stoichiometric number than CuFeS₂, which is consistent with Reaction 5. Experiments conducted with initial HCl concentrations of 2M and 3M were found to not be pH limited.

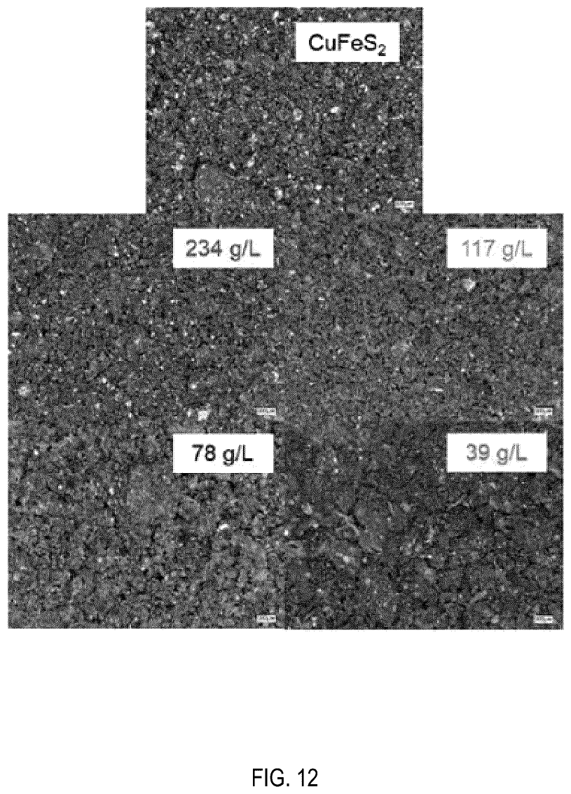

FIG. 12 shows images of the mineral products after 60 minutes of reduction with the Cr²⁺ ion obtained with a Keyence VHX-5000 microscope. Without wishing to be bound by theory, the results indicate that the mineral product is affected by the CuFeS₂ concentrate loading. The 39 g/L CuFeS₂ loading yielded a green product, which is consistent with the appearance of CuCl as well as other potential Cu—Cl complexes. The various mineral products were characterized and shown to yield different amounts of copper recovery. The mineral products post reaction with various HCl concentrations yielded the same trend in appearance.

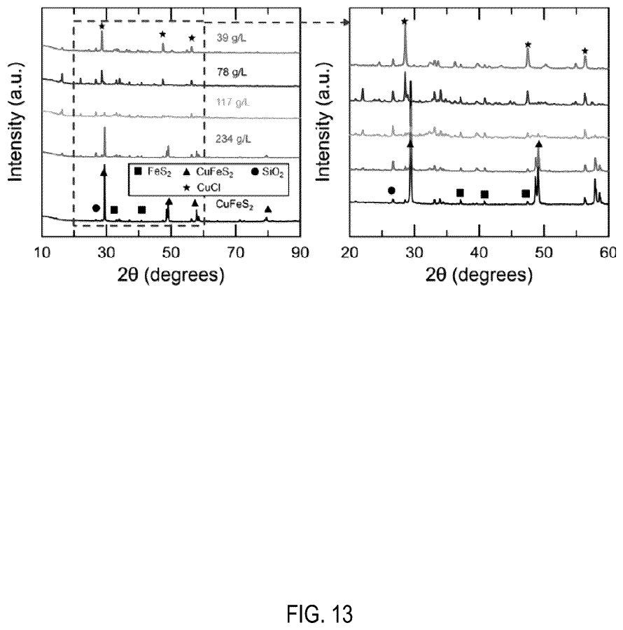

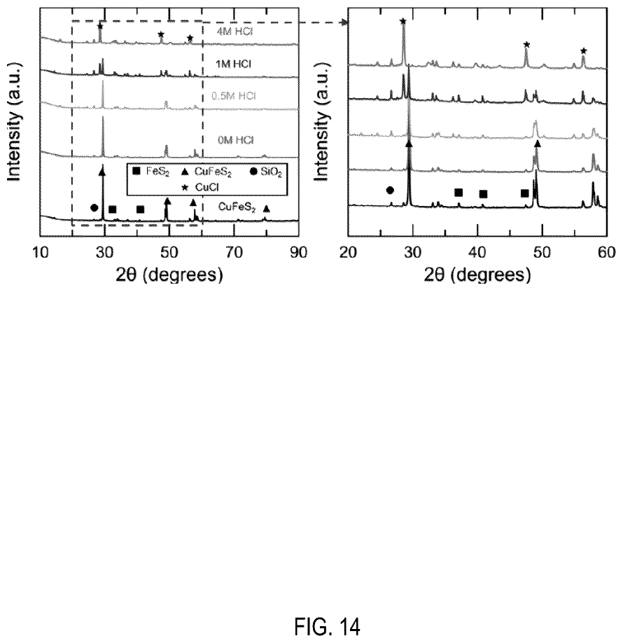

FIG. 13 shows the XRD spectra for the various chalcopyrite concentrate loadings subsequent to reaction with the Cr²⁺ ion, and FIG. 14 shows the XRD spectra for the mineral samples subsequent to reaction with the Cr²⁺ ion and various initial HCl concentrations. The predominant peaks of the unreacted CuFeS₂ concentrate were consistent with CuFeS₂, FeS₂, and SiO₂, as shown in Table 2. The relative intensity of the peaks associated with CuFeS₂ diminished for the reacted mineral products, consistent with the Fe²⁺ release measured by AAS. The peaks associated with the reaction products emerged for the mineral products with high conversion of CuFeS₂. The predominant mineral product was determined to be copper chloride (CuCl) from the spectra. Secondary products, such as Cu₂(OH)₃Cl, were consistent with the spectra. Reaction 11 shows the precipitation of CuCl out of solution, which is the primary product formed. Reaction 11 is shown for simplicity whereas the chemistry taking place is more complicated and a variety of Cu—Cl complexes may precipitate. The precipitation of CuCl out of the solution containing 4M HCl was unexpected considering that the molar ratio of Cl/Cu was 36 in the system. However, the molar ratio of Cl/Cr was 6, and therefore, complexes formed between Cl⁻ and Cr³⁺ may lower the number of Cl⁻ ions available to stabilize Cu⁺. The concentration of Cu⁺ in solution after 60 minutes of reduction was approximately 0.07M, which is close to the solubility limit of 0.233M reported at 2M HCl in the literature 36. It is estimated that 40% of copper in the system remained in the bulk solution as Cu⁺ and 60% precipitated out of solution for the experiments conducted with a concentrate loading of 39 g/L and an acid concentration of 4M HCl.

Cu⁺+Cl−→CuCl [11]

The XRD data, in conjunction with the AAS data, indicate that the FeS₂ and silicates were inert during the reductive treatment. Experiments were conducted between 39 g/L CuFeS₂ concentrate, 1M CrCl₂, 4M HCl and initial ferrous chloride (FeCl₂) concentrations of 0, 0.5M, 1M, and 2M. Without wishing to be bound by theory, it was determined that the reduction process can tolerate initial FeCl₂ concentrations of 1M and below. The Fe²⁺ precipitated out of solution for the experiment conducted with an initial FeCl₂ concentration of 2M.

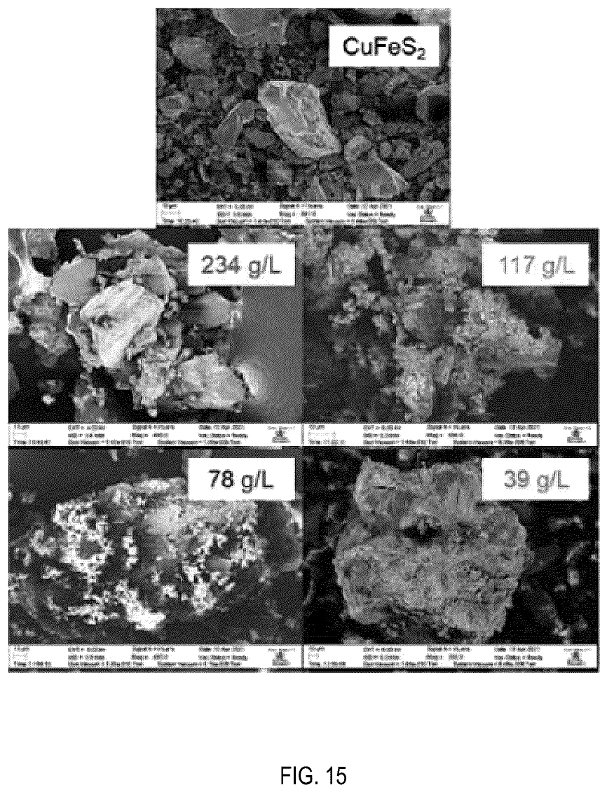

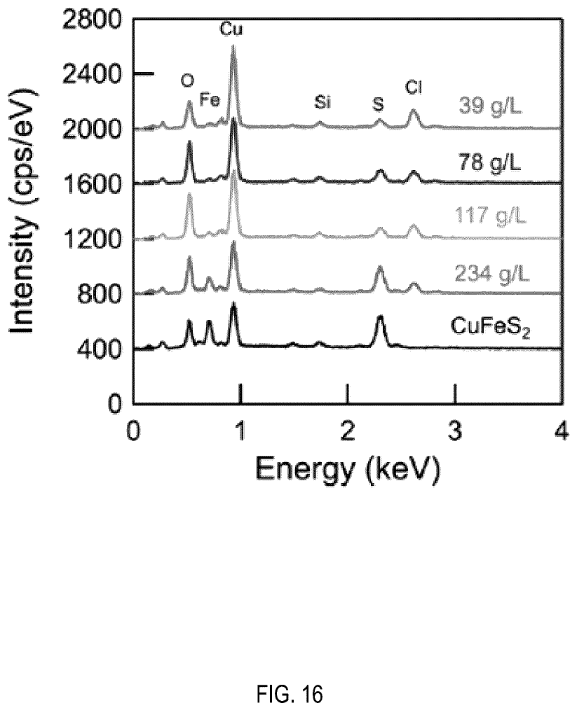

FIG. 15 shows SEM results for the mineral products after reaction with 1M CrCl₂ and 4M HCl for 60 minutes. The mineral products develop some mossy features, which may be related to the growth of CuCl. FIG. 16 shows EDS results for the mineral samples post reduction with the Cr²⁺ ion. The unreacted CuFeS₂ concentrate samples show peaks corresponding to Cu, Fe, S, Si, and O. The reacted samples show the diminishment in the Fe and S peaks, which is consistent with the release of Fe²⁺ to solution and the release of H₂S as a gas. The minor S peak present in the 39 g/L sample may be related to the presence of unreacted FeS₂ in the mineral products. The reacted samples also show the emergence of the Cl peak, which is consistent with the formation of CuCl. The Cu peak elongates for the reacted samples due to the increasing mass fraction of Cu within the samples. No peak corresponding to Cr was observed in the spectra, indicating that the presence of Cr within the samples is minor. The samples were digested in aqua regia and the mass fraction of Cr within the samples was estimated to be 1-3%. Without wishing to be bound by theory, the presence of chromium is thought to be an artifact of the procedure used to filter and dry the mineral products.

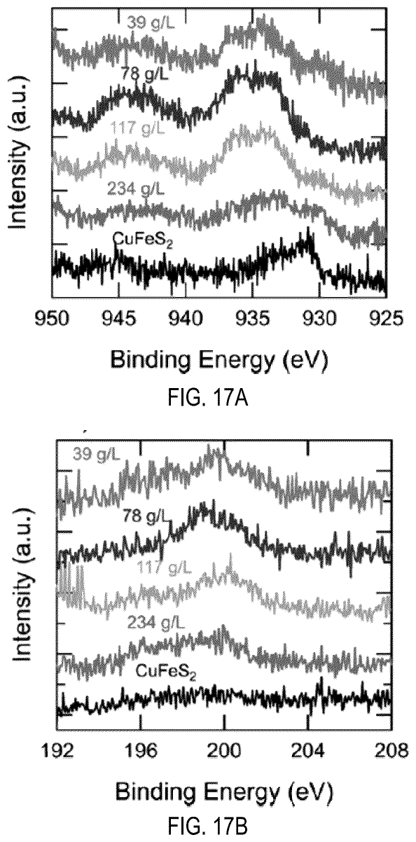

FIGS. 17A-17B shows the XPS spectra of Cu (FIG. 17A) and Cl (FIG. 17B) for the mineral samples post reduction with the Cr²⁺ ion. The Cr element was not observed on the mineral products, which further indicates that the samples were not comprised of chromium. Similarly, Fe and S were not observed on the surface of the mineral reaction products, which is consistent with the release of Fe²⁺ and H₂S from the surface of the particles into the solution phase. The absence of a sulfur passivation layer may account for the rapid kinetics of the reduction reaction. The various copper peaks indicate the presence of several copper-containing products. For instance, the peaks at the binding energies of 944 and 935 eV are assigned to Cu₂(OH)₃Cl and CuCl, respectively. The Cu scans also show an observable shift in binding energy from the CuFeS₂ concentrate standard. The emergence of a Cl peak for the reacted samples is consistent with the formation of Cu—Cl complexes.

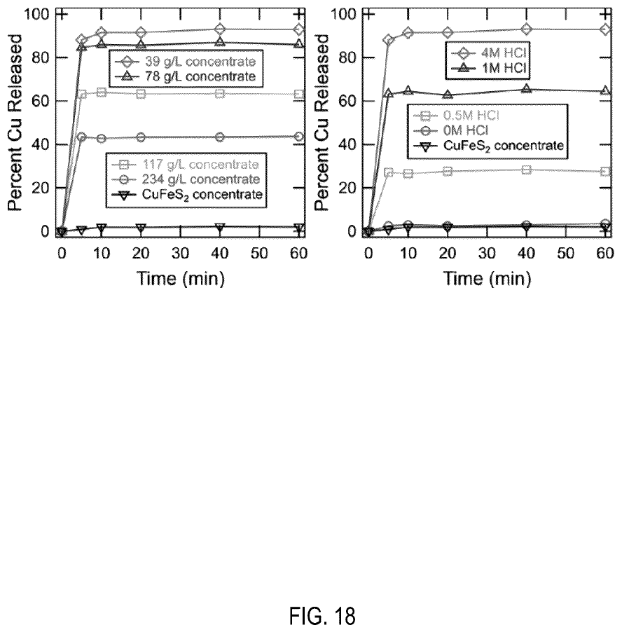

FIG. 18 shows the extraction of Cu²⁺ from the mineral products by 0.5M Fe₂(SO₄)₃. Reaction 12 shows the leaching reaction of CuCl by the Fe³¹ oxidant, which goes to completion within minutes.

CuCl+Fe³⁺→Cu²⁺+Cl⁻+Fe²⁺ [12]

The results show that virtually all of the Cu²⁺ can be extracted from the 39 g/L mineral product within minutes. In experiments, not shown, the 39 g/L sample was solubilized in 1M H₂SO₄. The aqueous solution may go to solvent extraction and electrowinning for the production of metallic copper. The incomplete copper extraction for higher pulp densities is at least partly related to the incomplete conversion of CuFeS₂ shown in FIGS. 11A-11B. Also, potential intermediates formed, such as Cu₂(OH)₃Cl, may be refractory for copper leaching and undesirable. It is shown that virtually no Cu²⁺ is extracted from the CuFeS₂ concentrate, and therefore, the reductive treatment directly leads to the extraction of copper.

Methods and systems of the present disclosure are advantageous to provide a transformative hydrometallurgical process to lower the costs of copper production and thereby sustain the use of copper throughout the global transition to renewable energy technologies. These embodiments enable the hydrometallurgical production of copper, which is more environmentally and economically sustainable than the current state of the art. Hydrometallurgical processing is preferred and used for other copper-mineral reserves such as copper oxides. The focal point of the hydrometallurgical process is the reductive treatment of chalcopyrite, which is in contrast to the oxidative treatment more commonly pursued in the literature. Without wishing to be bound by theory, the chemical reduction of CuFeS₂ is advantageous at least because it obviates the hydrogen evolution reaction and circumvents engineering challenges associated with slurry electrodes. Although the cost of vanadium and chromium are high relative to copper, a VRFB, or iron chromium flow battery (ICFB) may be leveraged to efficiently regenerate V²⁺ or Cr²⁺ at high current densities. The mineral products were leached by solutions including 1M H₂SO₄ and 1.5M Fe³¹ in 1M H₂SO₄ to demonstrate that the mineral products yield complete copper extraction.

A process flow diagram and associated technoeconomic analysis suggests that the reduction of chalcopyrite by an aqueous reductant may be competitive with the pyrometallurgical standard for copper production. Table 3 shows the investment and operating costs for steps in the hydrometallurgical process. The direct ($3.1/kg of Cu) and indirect ($2.4/kg of Cu) costs of copper production sum to $5.5/kg of Cu, which is lower than the estimated cost of the pyrometallurgical process.

TABLE 3
Estimated investment and operating costs of the chemical
reduction of CuFeS₂

| | Investment cost | Operating Cost |
|---|---|---|
| Component | ($/tonne of Cu per year) | ($/kg of Cu) |
| Open-Pit Mining | 10,000 | 0.5 |
| Ball Milling/Flotation | 10,000 | 1.3 |
| Electrochemical Device | ~650 | ~0.3 |
| Ore Reduction Reactor | ~500 | ~0.05 |
| Ore Dissolution Reactor | ~500 | ~0.05 |
| H₂S Treatment Reactor | ~500 | ~0.05 |
| Electrowinning | ~1000 | 0.15 |

It was assumed that the reduction and dissolution reactors have the same investment and operating costs as a solvent extraction plant, which includes the costs of a mixer, pumps, and storage tanks. This assumption was reasonable because the fast kinetics of the reactions lead to relatively small reactor volumes. The investment cost of the electrochemical device was estimated from scaling-up reported costs of a VRFB. It was estimated that a 20 MW VRFB is required to match the copper output of a typical smelter, which processes 4,000 tonnes of CuFeS₂ concentrate per day. The mass fraction of concentrate was assumed to be 0.3 and the nominal voltage of the electrochemical cell was assumed to be 1.35 V to perform these calculations. The operating cost of the electrochemical device was estimated from the industrial cost of electricity and assuming that one mole of vanadium is lost for every 20 moles of copper that is produced. The operating cost of the electrochemical device may fluctuate depending on the quality of the vanadium/iron separation and the selling price of V₂O₅.

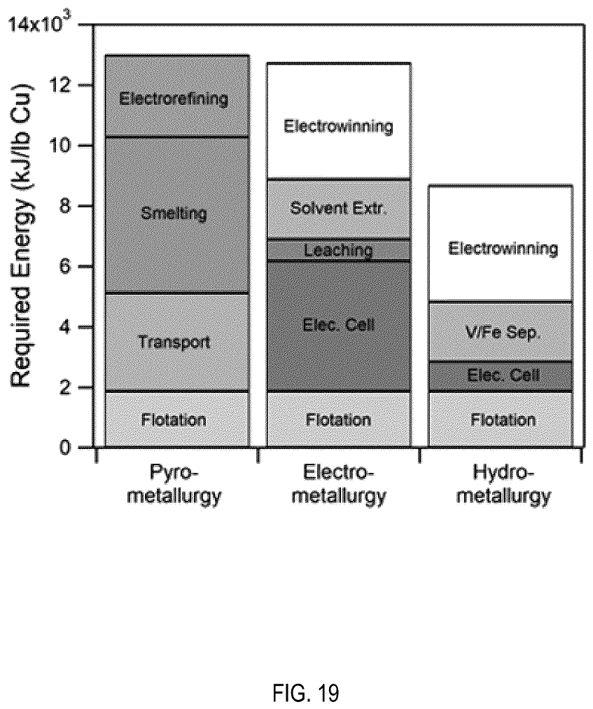

FIG. 19 shows the estimated energy requirement for the pyrometallurgical, electrometallurgical, and hydrometallurgical routes for Cu production after the ore has been mined and concentrated. The pyrometallurgical route has the highest energy requirement of approximately 13 kJ/lb Cu, which correlates to the release of significant amounts of CO₂. The electrometallurgical route has similar energy requirements due in part to the high energy requirements of the electrochemical cell. It was assumed that the electrochemical cell operates with a cell potential of 2.5 V and a faradaic efficiency of 40% to estimate its energy requirement. The hydrometallurgical route for Cu production is estimated to use approximately 8 kJ/lb Cu, which represents a significant reduction in global CO₂ emissions. It was assumed that the electrochemical cell operates with a cell potential of 1.35 V and a faradaic efficiency of 95% to estimate its energy requirement. Also, it was assumed that a V/Fe separation step has the same energy requirement as conventional solvent extraction.

As discussed above, the global mining industry is interested in hydrometallurgical routes to convert chalcopyrite to copper due to environmental and economic pressures. The embodiments of the present disclosure are potentially less expensive and less polluting than current pyrometallurgical processing, and would also allow increased domestic production of copper in the USA.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of producing a copper product from a copper concentrate, the method comprising:
providing a composition including a copper concentrate;
contacting the composition with an aqueous solution including one or more chemical reducing agents;
reacting at least a portion of the copper concentrate with the chemical reducing agent to reduce copper within the copper concentrate; and
isolating a solid phase reaction product, the solid phase reaction product including a copper product.

2. The method according to claim 1, wherein the copper concentrate includes chalcopyrite.

3. The method according to claim 1, further comprising:
contacting the solid phase reaction product with an acidic stream to produce a dissolved copper product, the acidic stream including one or more acids.

4. The method according to claim 3, wherein the acidic stream includes a concentration of iron (III) sulfate, sulfuric acid, or combinations thereof.

5. The method according to claim 3, electrowinning the dissolved copper product to isolate the copper product and a recycled acid.

6. The method according to claim 1, wherein the step of isolating a solid phase reaction product further comprises:
isolating a liquid phase reaction product, the liquid phase reaction product including an oxidized chemical reducing agent; and
feeding the liquid phase reaction product to an electrochemical device.

7. The method according to claim 6, further comprising:
reducing the oxidized chemical reducing agent at the electrochemical device to a recycled chemical reducing agent; and
contacting the recycled chemical reducing agent with the composition.

8. The method according to claim 6, further comprising:
isolating a second copper product from the liquid phase reaction product.

9. The method according to claim 1, wherein the chemical reducing agents include vanadium (II) ions, compounds including vanadium (II) ions, chromium (II) ions, compounds including chromium (II) ions, tungstozincic acid (H₆ZnW₁₂O₄₀), or combinations thereof.

10. The method according to claim 9, the chemical reducing agents include vanadium (II) sulfate, chromium (II) chloride, or combinations thereof.

11. The method according to claim 1, wherein the step of isolating a solid phase reaction product further comprises:
isolating a gaseous reaction product, the gaseous reaction product including hydrogen sulfide;
contacting the gaseous reaction product with a stream of ferric iron to form a ferrous iron effluent stream and an elemental sulfur effluent stream; and
recycling the ferrous iron effluent stream to the electrochemical device.

12. A system for producing a copper product from a copper concentrate, the system comprising:
a source of copper concentrate;
a reduction reactor in communication with the source of copper concentrate, the reduction reactor including:
an acidic aqueous solution including one or more chemical reducing agents; and
at least a first product outlet;
a solid phase product outlet stream in communication with the first product outlet;
a dissolution reactor in communication with one or more acid inlet streams and the solid phase product outlet stream, the dissolution reactor producing a dissolved copper product stream; and
a copper isolation electrowinning reactor in fluid communication with the dissolved copper product stream, the copper isolation electrowinning reactor producing a copper product and a recycled acid stream in fluid communication with the dissolution reactor.

13. The system according to claim 12, wherein the copper concentrate includes chalcopyrite.

14. The system according to claim 12, wherein the chemical reducing agents include vanadium (II) ions, compounds including vanadium (II) ions, chromium (II) ions, compounds including chromium (II) ions, tungstozincic acid (H₆ZnW₁₂O₄₀), or combinations thereof.

15. The system according to claim 14, the chemical reducing agents include vanadium (II) sulfate, chromium (II) chloride, or combinations thereof.

16. The system according to claim 12, wherein the acid inlet stream includes a concentration of iron (III) sulfate, sulfuric acid, or combinations thereof.

17. The system according to claim 13, wherein the reduction reactor further comprises a second product outlet, and wherein the system further comprises:
a liquid phase product outlet stream in fluid communication with the second product outlet, the liquid phase product stream including oxidized chemical reducing agent;
an electrochemical device in fluid communication with the liquid phase outlet stream; and
a recycled chemical reducing agent stream produced by the electrochemical device and in fluid communication with the reduction reactor.

18. The system according to claim 17, wherein the reduction reactor further comprises a third product outlet, and wherein the system further comprises:
a gaseous phase product outlet stream in fluid communication with the third product outlet, the gaseous phase product outlet stream including hydrogen sulfide;
a gaseous treatment reactor in fluid communication with the gaseous phase product outlet stream;
a ferric iron feedstream provided from the electrochemical device to the gaseous treatment reactor;
a ferrous iron feedstream provided from the gaseous treatment reactor to the electrochemical device; and
an elemental sulfur effluent stream.

19. A method for indirect reduction of chalcopyrite, comprising:
providing a composition including a concentration of chalcopyrite;
contacting the composition with an acidic aqueous solution including one or more acids and one or more chemical reducing agents, wherein the one or more acids include sulfuric acid, hydrochloric acid, or combinations thereof, and wherein the one or more chemical reducing agents include vanadium (II) ions, compounds including vanadium (II) ions, chromium (II) ions, compounds including chromium (II) ions, tungstozincic acid (H₆ZnW₁₂O₄₀), or combinations thereof;
reacting the chalcopyrite with the chemical reducing agents to reduce at least a portion of the copper included therein;
separating a solids reaction product stream, a liquid reaction product stream, and a gaseous reaction product stream, wherein:
the solids reaction product stream includes copper, copper compounds, or combinations thereof,
the liquid reaction product stream includes oxidized chemical reducing agent, and
the gaseous reaction product stream includes H₂S;
providing the oxidized chemical reducing agent to an electrochemical device;
reducing the oxidized chemical reducing agent at the electrochemical device to a recycled chemical reducing agent;
contacting the recycled chemical reducing agent with the composition;
treating the gaseous reaction product stream with a concentration of ferric iron to generate a sulfur product and a concentration of ferrous iron;
recycling the ferrous iron to the electrochemical device;
contacting the solids reaction product stream with one or more acids to produce a dissolved copper product stream; and
electrowinning the dissolved copper product stream to isolate a copper product and a recycled acid.

20. The method according to claim 19, wherein the acidic aqueous solution has a concentration of about 0.01M to about 10 M of reducing agent.
